(19) United States
(12) Patent Application Publication
(10) Pub. No.: US 2007/0133947 A1
(43) Pub. Date: Jun. 14, 2007

(54) Systems and methods for image search

(76) Inventors: William Armitage, Concord, MA (US); Benjamin N. Lipchak, Boylston, MA (US); John E. Owen JR., Medway, MA (US); Thomas E. Frisinger, Hudson, MA (US)

Correspondence Address: GOODWIN PROCTER LLP;PATENT ADMINISTRATOR, EXCHANGE PLACE, BOSTON, MA, 02109-2881, US

(21) Appl. No.: 11/589,294

(22) Filed: Oct. 27, 2006

Related U.S. Application Data
(60) Provisional application No. 60/731,420, filed on Oct. 28, 2005.

(51) Int. Cl. H04N 7/00

(52) U.S. Cl. 386/95

(57) ABSTRACT

The invention relates to systems and methods for searching using images as the search criteria. In one aspect, video is searched using images as search criteria. In another aspect, images are used to search for items for purchase, for example, in a store or in an auction context.

### RELATED APPLICATIONS

This application claims the benefit of, and priority to, U.S. Provisional Patent Application Ser. No. 60/731,420, filed on Oct. 28, 2005, entitled “SYSTEMS AND METHODS FOR IMAGE SEARCH,” attorney docket No. EIK-001PR, incorporated herein by reference.

### TECHNICAL FIELD

The invention relates to image search, for example, to searching for images over a network such as the Internet, on local storage, in databases, and private collections.

### BACKGROUND

With the ever-increasing digitization of information, the use of digital images is widespread. Digital images can be found on Internet, in corporate databases, or on a home user's personal system, as just a few examples. Computer users often wish to search for digital images that are available on a computer, database, or a network. Users frequently employ keywords for such searching. A user may search, for example, for all images related to the keyword “baseball” and subsequently refine his or her search with the keyword “Red Sox.” These types of searches rely upon keyword-based digital image retrieval systems, which classify, detect, and retrieve images from a database of digital images based on the text associated with the image rather than the image itself. Keywords are assigned to, and associated with, images, and a user can retrieve a desired image from the image database by submitting a textual query to the system, using one keyword or a combination of keywords.

### SUMMARY OF THE INVENTION

Embodiments of the invention can provide a solution to the problem of how to quickly and easily access and/or categorize the ever-expanding number of computer images. Embodiments of the invention provide image searching and sharing capability that is useful to Internet search providers, such as search services available from Google, Yahoo!, and Lycos, to corporations interested in trademark searching and comparison, for corporate database searches, and for individual users interested in browsing, searching, and matching personal or family images.

Embodiments of the invention provide capabilities not otherwise available, including the ability to search the huge number of images on the Internet to find a desired graphic. As one example, firms can scan the Internet to determine whether their logos and graphic trademarks are being improperly used, and companies creating new logos and trademarks can compare them against others on the Internet to see whether they are unique. Organizations with large pictoral databases, such as Corbis or Getty, can use systems and techniques as described here to provide more effective access. With the continued increases in digital camera sales, individual users can use embodiments of the invention to search their family digital image collections.

Embodiments of the invention use color, texture, shapes, and other visual cues and related parameters to match images, not just keywords. Users can search using an image or subimage as a query, which image can be obtained from any suitable source, such as a scanner, a digital camera, a web download, or a paint or drawing program. Embodiments of the invention can find images visually similar to the query image provided, and can be further refined by use of keywords.

In one embodiment, the technology can be implemented with millions of images indexed and classified for searching, because the indexed information is highly concentrated. The index size for each image is a very small fraction of the size of the image. This facilitates fast and efficient searching.

In one embodiment, a web-based graphic search engine is configured to allow users to search large portions of the Internet for images of interest. Such a system includes search algorithms that allow queries to rank millions of images at interactive rates. While off-line precomputation of results is possible under some conditions, it is most helpful if algorithms also can respond in real-time to user-specified images.

The system also includes algorithms to determine the similarity of two images whether they are low resolution or high resolution, and enabling a lower detail image such as a hand-drawn sketch to be matched to high detail images, such as photos. The system can compare color, such as an average color, or color histogram, and it can do so for the overall image, and/or for portions or segments of the image. The system can compare shape of spacially coherent regions. The system can compare texture, for example, by comparing frequency content. The system can compare transparency, by performing transparency matching, or identifying regions of interest. The system can use algorithms to determine matches of logos or subimages, algorithms for determining the similarity of images based on one or more of resolution, color depth, or aspect ratio, and an ability and mechanism to “tune” for similarity. The system also can provide the capability to allow a user to converge on a desired image by using iterative searches, with later searches using results from previous searches as a search request.

Multiple similarity metrics can be weighted, by user, or automatically based on search requested, with intelligent defaults for a given image. Results on each metric can be viewed independently or in some combination. The resulting domain can be limited by keywords, image size, aspect ratio, image format, classification (e.g., photo/non-photo), and the results display can be customizable to user preferences.

Systems for image search such as that described have a number of applications. As a few examples, the technology can be used to associate keywords in an automated fashion to enhance searching, to rank Internet sites based on visual image content for relevance purposes, to filter certain images such as images which may be unsuitable, to find certain images that may not be used properly for policing purposes, and more.

For example, in one embodiment, the technology described here can be used for human-supervised mass assignment of keywords to images based on image similarity. This can be useful for generating keywords in an efficient manner. Likewise, the technology can be used to identify similar images that should be filtered, such as for filtering of pornography, or images that may be desired to be found, such as corporate logos. In both cases, an image can be identified and keywords assigned. Similar images can be identified and presented, and a user interface used that facilitates the simple selection or deselection of images that should be associated with the keyword.

Moreover, when keywords are assigned with automated assistance, it becomes possible to rank a web site, for example, by the number of keywords that are associated with images on the web page. The quantity and quality of the keyword matches to the images can be a useful metric for page relevance, for example. Also, the technology enables a search based on images, not keywords, or in combination with keyword searches, with a higher relevance score assigned to sites with the closest image matches. This technique can be used to identify relevant sites even if the images are not already associated with keywords.

A system implementing the techniques described can be used for detection of “improper” images for filtering or policing(e.g., pornography, hateful images, copyright or trademark violations, and so on) , and can do so by finding exact image matches, nearly identical image matches, or similar image matches, even if watermarking, compression, image format, or other features are different.

In general, in one aspect, the invention relates to an image search method that includes the steps of accepting a digital input image, and searching for images similar to the digital input image. The searching step includes decomposing the digital input image into at least one mathematical representation representative of at least one parameter of the digital image, using the mathematical representation to test each of a plurality of database images stored in a database, and designating as matching images any database images having a selected goodness-of-fit with the mathematical representation of the input image. The method also includes compiling the matching images into a set of matching images. A system for implementing such a method includes means for implementing each of these steps, for example, software executing on a computer such as an off-the-shelf personal computer or network server.

Those skilled in the art will appreciate that the methods described herein can be implemented in devices, systems and software other than the examples set forth herein, and such examples are provided by way of illustration rather than limitation.

### BRIEF DESCRIPTION OF THE DRAWINGS

FIG. 1 is a schematic of an embodiment of a system according to the invention.

FIGS. 2-6 are exemplary screen displays in an embodiment of the invention.

FIG. 7 shows operation of an exemplary implementation of an embodiment of the invention.

FIG. 8 shows operation of an exemplary implementation of an embodiment of the invention.

FIG. 9 shows operation of an exemplary implementation of an embodiment of a system according to the invention.

FIG. 10 shows operation of an exemplary implementation of an embodiment of a system according to the invention.

FIG. 11 is a flowchart showing operation of an exemplary embodiment of a method according to the invention.

FIG. 12 shows operation of an exemplary implementation of an embodiment of a system according to the invention.

FIG. 13 is a flowchart showing operation of an exemplary embodiment of a method according to the invention.

### DETAILED DESCRIPTION

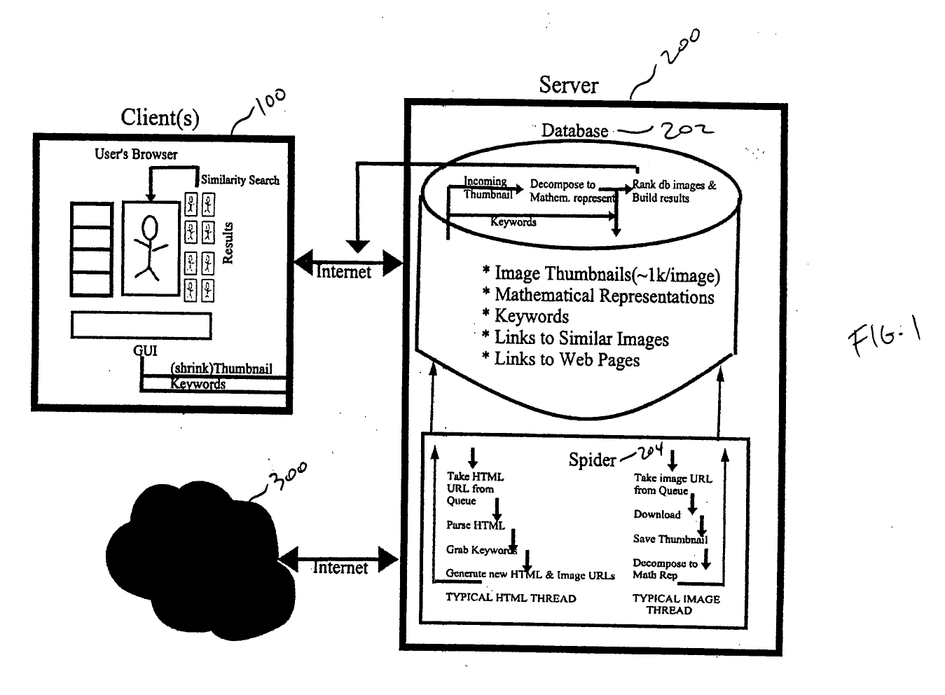

Referring to FIG. 1, a schematic diagram depicting the significant processing modules and data flow in an embodiment of the invention includes the client's processing unit 100, which may include, by way of example, a conventional personal computer (PC) having a central processing unit (CPU), random access memory (RAM), read-only memory (ROM) and magnetic disk storage, but which can be any sort of computing or communication device, including a suitable mobile telephone or appliance. The system includes a server 200, which can also incorporate a CPU, RAM, ROM and magnetic and other storage subsystems. In accordance with known networking practice, the server 200 can be connected with the client's system 100 via the Internet (shown at various points in FIG. 1 and associated with reference numeral 300).

In an alternative embodiment, which is “stand-alone,” all the features indicated in server 200 may be incorporated into a client's computer 100.

As shown in FIG. 1, the client processor 100 contains elements for supporting an image browser implementing aspects of the invention, in conjunction with a conventional graphical user interface (GUI), such as that supported by the Windows 98 (or Windows NT, Windows XP, Linux, Apple Macintosh, and so on). The client can accept input from a human user, such as, for example, a hand-drawn rendering of an image, using a drawing application, e.g., Microsoft Paint, or a particular “thumbnail” (reduced size) image selected from a library of images, which can be pre-loaded or created by the user. The user's input can also include keywords, which may be descriptive of images to be searched for. In conjunction with the remainder of the system, similarity searches are executed, to locate images similar to the user's thumbnail image and/or one or more keywords input by the user, and the results displayed on the user's monitor, which forms part of client system 100. The searching can be performed iteratively, such that one selected result from a first search is used as the basis for a second search request, such that a user can converge on a desired image by an iterative process.

In a networked embodiment of the system, such as an Internet-based system, input from the user can be transmitted via a telecommunications medium, such as the Internet, to a remote server 200 for further search, matching, and other processing functions. Of course, any suitable telecommunications medium can be used. As indicated in the figure, the server 200 can include a database and a spider 204 function. The database, which can be constructed in accordance with known database principals, can, for example, include a file, B-tree structure, and/or any one of the number of commercially available databases, available for example from Oracle, Progress Software, MySQL, and the like. The database can in various implementations store such items as digital image thumbnails, mathematical representations of images and image parameters, keywords, links to similar images, and links to web pages. This information is used to identify similar images.

As further indicated in FIG. 1, within the server 200, various processes and subroutines are executed. In particular, the server can receive an incoming keyword and/or digital image, decompose the image into a set of mathematical representations, and search for and select matching images from the database. The images can be ranked for relevancy, for example, and results generated.

In one embodiment of the invention, the foregoing functions can be executed by a “spider” 204. As shown in FIG. 1, the spider 204 takes a HTML URL from a queue and parses the HTML code in accordance with known HTML processing practice. The spider also uses any keywords generated by the user, and generates new HTML and image URL's. The foregoing functions constitute a typical HTML thread within the system. In one implementation of an image thread, the spider downloads the image URL listed in the queue, downloads, saves the image thumbnail, and then decomposes the thumbnail into mathematical representation(s) thereof. In another implementation, which is implemented as a parallel process, the spider first downloads the original image data and later (in either order) a thumbnail is generated from the original image and one or more mathematical representation(s) of the original image are generated, such that the thumbnail and the mathematical representation are both byproducts of the original image.

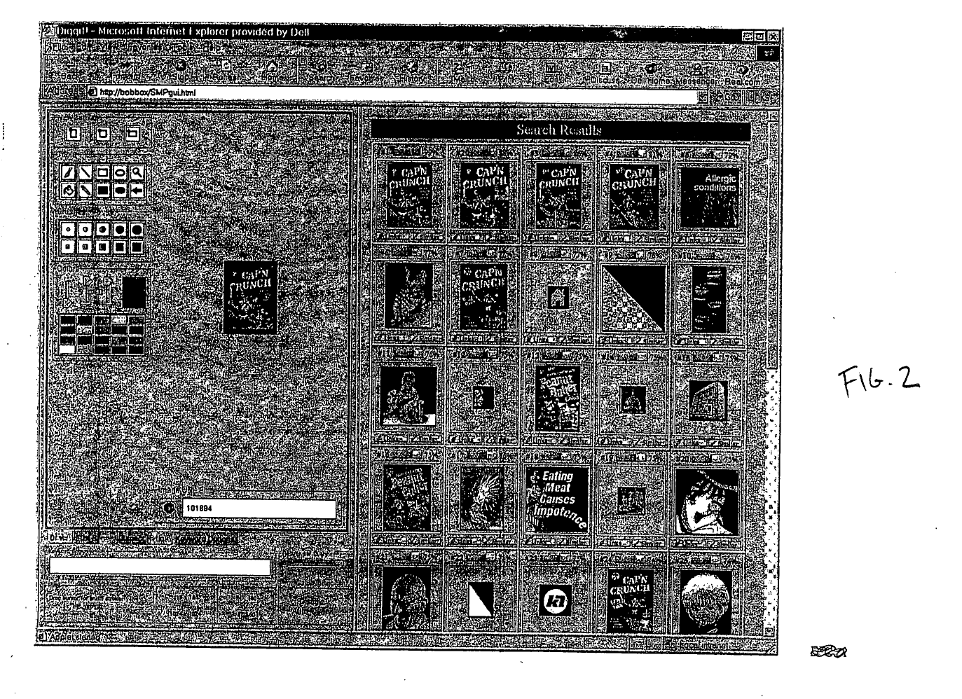

The foregoing functions are further illustrated by exemplary “screen shots” of FIGS. 2-6, which illustrate exemplary displays provided by the system on a user's monitor as a result of selected searches. In FIG. 2, for example, the user has selected a thumbnail image of a “CAP'N CRUNCH” cereal box, and actuated a search for images matching that thumbnail. The CAP'N CRUNCH thumbnail could be, for example, selected by the user from a database of images present on the user's own computer 100, or such a search might be generated, for example, by a user seeking images from anywhere on the Internet that closely approximates the appearance of the CAP'N CRUNCH cereal box. Some parameters of that search are indicated in the various sectors of the screen shot.

Upon executing the image search and filtering functions described herein, the results of the search are displayed on the right-hand portion of the screen. As illustrated in the figure, twenty-five results, numbered 1-25 are shown in the screen shot. Each result has associated with it a percentage indicating the degree of similarity. This similarity is based on various configurable parameters, including color, shape, texture, and transparency, as noted above. In the example shown in FIG. 2, result #1 has a 99% matching percentage, while result #25 has only a 74% matching percentage. In each case, the user can also click on “Links” or “Similar” to access images that are hyperlinks to the selected images, as well as to obtain further images similar to the selected images. In some cases, it may be helpful to have the links point to pages on which the image was found, so that it can be viewed in context, or to display the image with context information. The image can be displayed with useful context or content information, which can also be links to additional information or content.

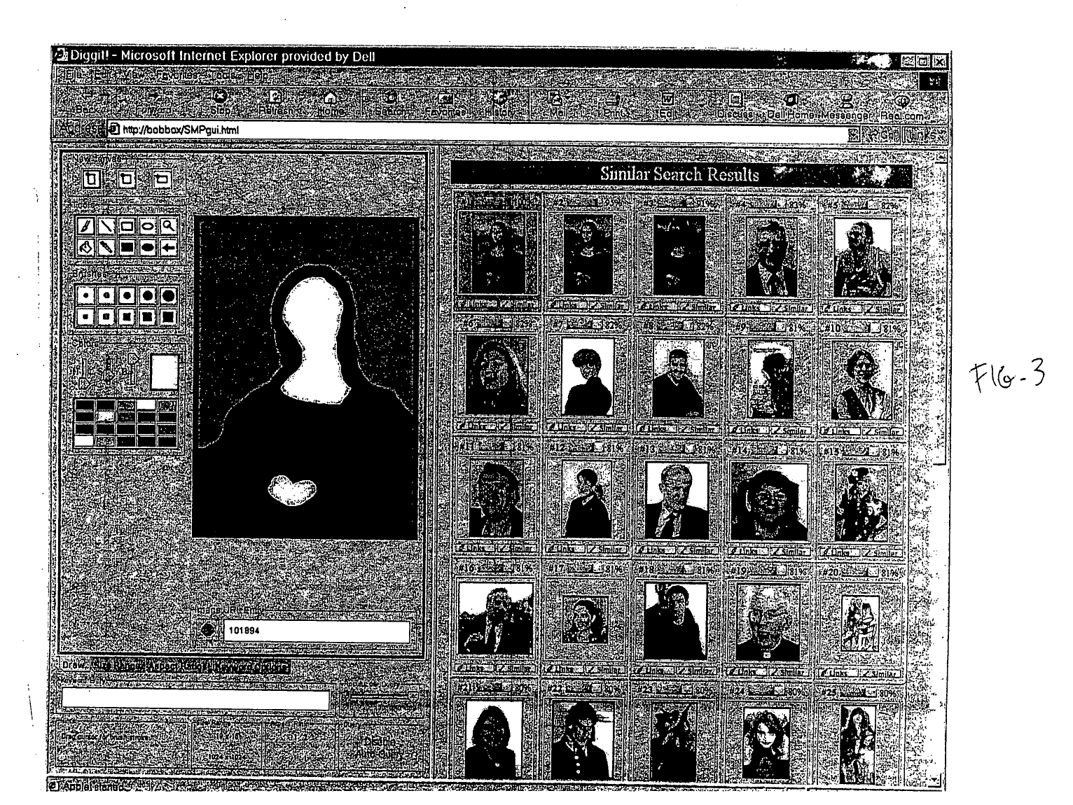

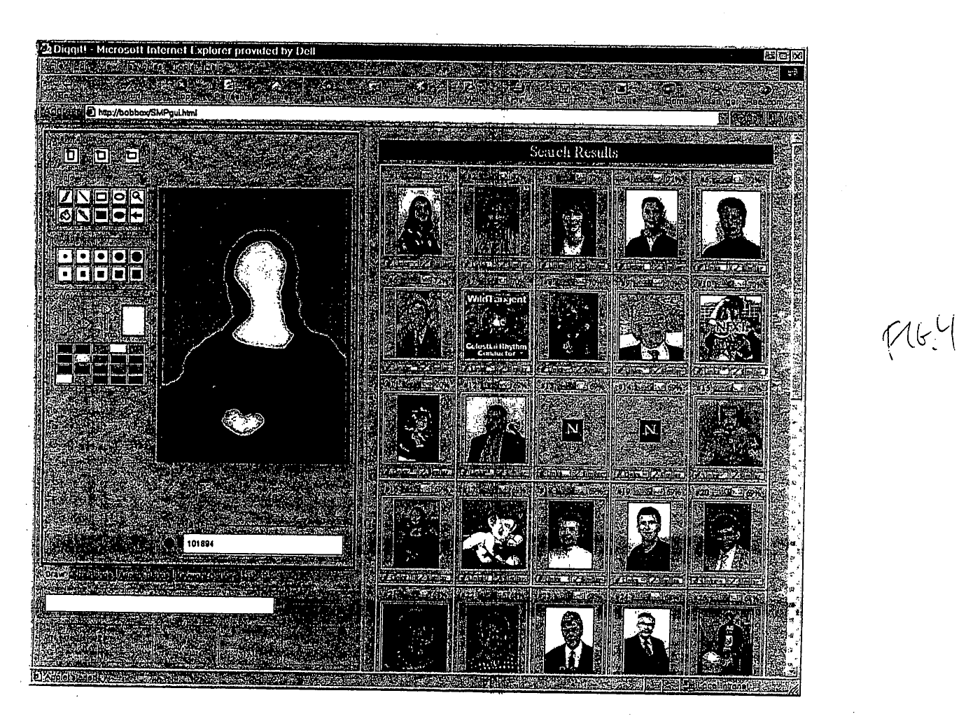

FIGS. 3-6 show other examples. In FIG. 3, for example, the user has employed the mouse or other pointing device associated with the user's computer, in conjunction with drawing software, in this case off-the-shelf software such as Microsoft Paint or the like, to create a sketch reminiscent of Leonardo Da Vinci's Mona Lisa. The “face” portion of the user's sketch input has been left blank, such that the mysterious Mona Lisa smile is absent. The user then requests a search for similar images. The search results, in thumbnail form, are depicted on the right-hand side of the screen shot. Again, 25 thumbnail images, numbered 1-25, are depicted, with image #1 —a depiction of the Mona Lisa itself—having a 99% similarity rating. FIG. 4 depicts an additional set of results, with lower similarity ratings, ranging from 73% to 68%.

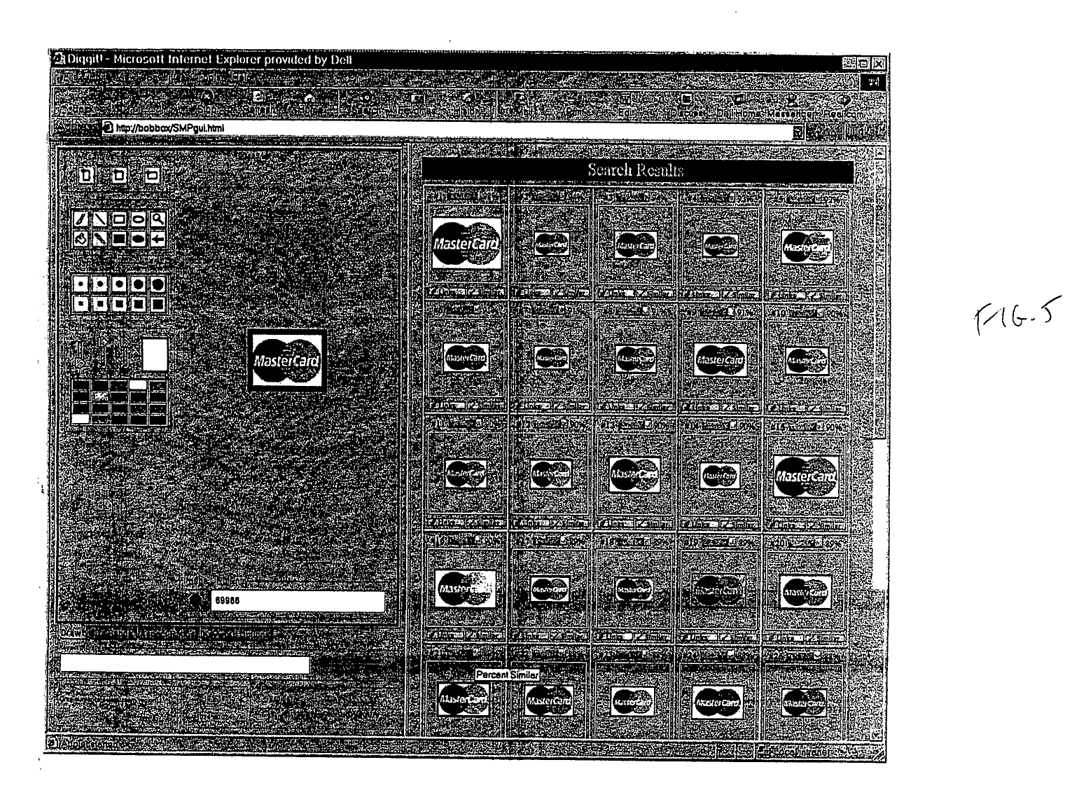

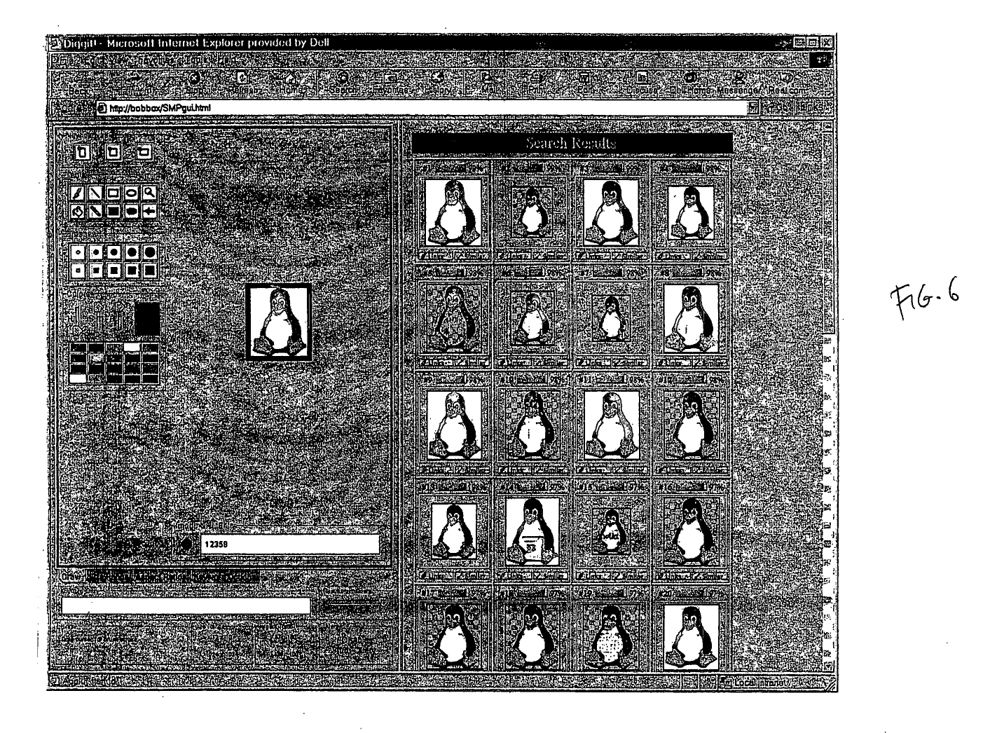

FIG. 5 and FIG. 6 illustrate the utility of the system in checking the Internet for trademark or logo usage. In FIG. 5, the MASTERCARD words mark and overlapping circles logo are input by the user. The search identified 25 similar images in the search results depicted on the right-hand side of the screen shot, with similarity ratings of 98% to 88%. In FIG. 6, a search is conducted for images similar to the Linux penguin.

Each of the examples described here can use the techniques described above. Alternatively, other search algorithms can be used with effective results. By way of example, the Spatial and Feature query system (SAFE), described in the Appendix hereto, is a general tool for spatial and feature image search. It provides a framework for searching for and comparing images by the spatial arrangement of regions or objects. Other commercially available search systems and methods also can be used. By way of further example, also as discussed in the Appendix hereto, IBM's commercially available Query by Image Content (QBIC) system navigates through on-line collections of images. QBIC allows queries of large image databases based on visual image content using properties such as color percentages, color layout, and textures occurring in the images. Likewise, the Fast Multiresolution Image Querying techniques can be used. These and other searching algorithms can be used in connection with the clustering system and methods of the present invention, as described herein.

It will be apparent to those skilled in the art that the digital searching system of the present invention can be used to search and present digital images from a variety of sources, including a database of images, a corporate intranet, the Internet, or other such sources.

Image Clustering

In one embodiment, image clustering is used to classify similar images into families, such that one member of a family is used in a search result to represent a number of family members. This is useful for organization and presentation. In one embodiment, as a pre-computation step, an image database is organized into clusters, or families. Each family contains all of the images within a selected threshold of visual similarity. In response to a user's query, only a representative—the “father node”—from each family is presented as a result, even if more members of the family are relevant. The user can choose to “drill down” into the family and review more members of the family if desired.

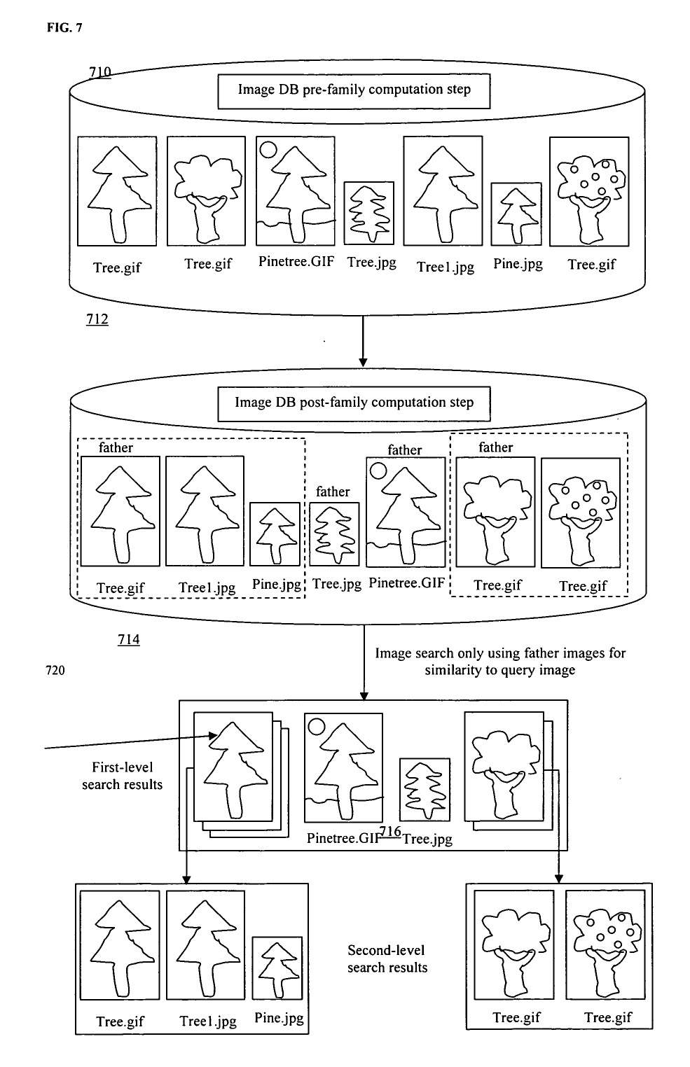

Referring to FIG. 7, a method of digital searching based on image clustering is shown. An exemplary database 710 is first shown prior to the “family computation step,” which involves the construction of family groups, or clusters, in accordance with the invention. Images are collected and organized in a conventional image database 710 in accordance with known image database practice. There is, for example, one database index entry for each image, and there is no organization in the database based on image similarity.

In the exemplary implementation, the images in the database 710 are compared and similar images are organized into clusters, or families. Each family contains all of the images within a selected threshold of visual similarity. The database 712 is shown after the family computation, with the clustering shown as groups: Images that are similar to each other are grouped together. Each family has a representative member, designated as the “father.” Images that are not similar to any other image in the database have a family size of one. In the illustrated embodiment, only fathers are given top-level indexes in the database.

When a query is made, a representative—the “father” node—from each family is examined during the search. When the results are displayed, only the representative of the family is displayed. If the user wants to see more family members, the user can browse down through the family of images.

Exemplary first-level search results 714 are shown in the figure. The first-level results include the images for families of size one, and representative father images for families. In one embodiment, the system displays family results in a Graphical User Interface (GUI), as a stack of images, such as that denoted by reference numeral 720, which is used to indicate to a user that a family of images exists. The user can then look down through the stack of images, or further explore the images by “clicking” on the father image or the stack of images in accordance with conventional GUI practice.

Exemplary second level results 716 are for image families with more the one member. At this level, images belonging to the family are displayed. Particularly large families of nearly identical images may be further broken down into multiple generation levels for display purposes. For example, after drilling down into a family of images, there may yet be more representatives of sub-families into which the user may drill. Again, the first-level family representatives are used during searches. The extended hierarchy within the families is simply used for allowing access to all members of the family while increasing the variety at any given level.

Enhanced Keyword Specification Techniques

In general, in another aspect, the invention relates to a method and system that can be used to assign keywords to digital images. In one embodiment, after images have been collected, some images have keywords already assigned. Keywords may be assigned, for example, by human editors, or by conventional software that automatically assigns keywords based on text near the image on the web page that contains the image. An implementation can then perform a content-based search to find “visually similar” images for each image that has one or more assigned keywords. Every resulting image within a pre-determined similarity threshold inherits those keywords. Keywords are thus automatically assigned to each image in a set of visually similar images.

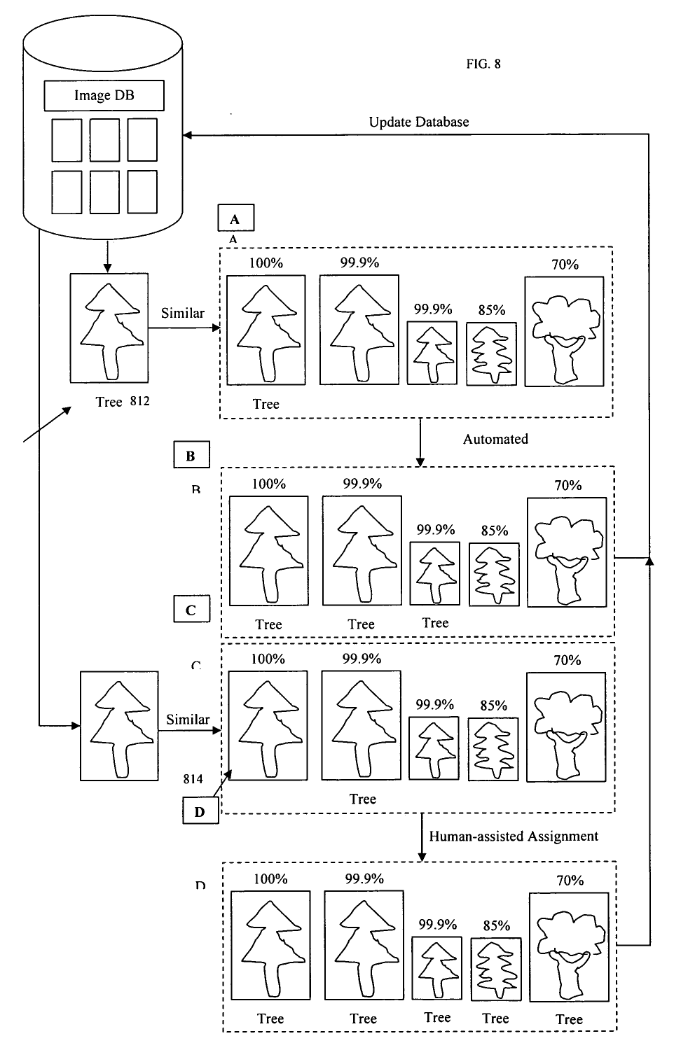

Referring to FIG. 8, an exemplary embodiment for automatically assigning keywords to images in a database is shown.

By way of example, the present invention can be advantageously employed in connection with conventional image search engines, after a database of images has been generated by conventional database population software. An example of such a database can be found at Yahoo! News, which provides access to a database of photographs, some of which have been supplied by Reuters as images and associated text. In one embodiment, a starting point for application of the invention is a pre-existing, partially keyword-associated image database, such as, for example, the Reuters/Yahoo! News database. As in that example, the database can be created with some previously-assigned keywords, whether assigned by human editors, or automatically from nearby text on web pages on which those images are found. For each image having keywords, the system of the present invention performs a content-based search to find visually similar images. When the search has been performed, every resulting image within a selected small threshold range, such as a 99.9% match, then automatically inherits those keywords.

In one embodiment of the invention, an image database that has only a few or even no keywords can also be used as a starting point. According to this method, a human editor selects from the database an image that does not yet have any associated keywords. The editor types in one or more keywords to associate with this image. A content-based image search is then performed by the system, and other, e.g., a few hundred, visually similar images can be displayed. The editor can quickly scan the results, select out the images that do not match the keywords, and authorize the system to associate the keywords with the remaining “good” matches.

Referring again to FIG. 8, the system contains an exemplary group of images, shown at A. During an automated keyword assignment, an image 812 with one or more associated keywords is selected from the database. A “similar image search” is performed to find visually similar images. Some of the resulting images may already have had keywords assigned to them. At step B, images with a high degree of similarity are assigned the keywords of the query image if they do not already have an associated keyword.

In the process of human-assisted keyword assignment, a system user may also choose an image 814 that does not have keywords associated with it. In this case, shown as C, the human editor can add one or more keywords to the image and then authorize the system to perform a similar image search. The editor can then scan the results of the similar image search, and select which images should or should not have the same keywords assigned to them. One advantage of this method is that more images can be assigned keywords because of the relaxed notion of similarity.

As shown in Step D, the database is then updated with the newly assigned keywords, and the process can start again with another image.

Content Filtering

In another embodiment, a web “spider” or “crawler” autonomously and constantly inspects new web sites, and examines each image on the site. If the web spider finds an image that is present in a known prohibited content database, or is a close enough match to be a clear derivative of a known image, the entire site, or a subset of the site, is classified as prohibited. The system thus updates a database of prohibited web sites using a web spider. This can be applied to pornography, but also can be applied to hateful images or any other filterable image content.

In one exemplary embodiment, the system has a database with known-pornographic images. This database can be a database of the images themselves, but in one embodiment includes only mathematical representations of the images, and a pointer to the thumbnail image. The database can include URLs to the original image and other context or other information.

A web-spider or web-crawler constantly examines new websites and compares the images on each new website against a database of known-pornographic images. If the web spider finds an image that matches an image in a database of known-pornographic images, or if the image is a close enough match to be a clear derivative of a known pornographic image, the entire website, or a subset thereof, is classified as a pornographic website.

In another embodiment, in a dynamic on-the-fly approach, a filtering mechanism, which can filter web pages, email, text messages, downloads, and other content, employs a database of mathematical representations of undesirable images. When an image is brought into the jurisdiction of the filtering mechanism, for example via e-mail or download, the filter generates a mathematical representation of the image and compares that representation to the known representations of “bad” images to determine whether the incoming image should be filtered. If the incoming image is sufficiently similar to the “filtered” images, it too will be filtered. In one embodiment, the mathematical representation of the filtered image is also added to the database as “bad” content. Also, the offending site or sender that provided the content can be blocked or filtered from further communication, or from appearing in future search results.

The output of search engines, or virtually any web-based or internet-based transmission, can be filtered using available image searching technologies, and undesirable websites can be removed from a list of websites that would otherwise be allowed to communicate or to be included in search results.

It has been said that very few unique images on the web are pornographic, and that almost all pornographic images are present on multiple pornography sites. If so, using the described techniques, a web site can quickly and automatically be accurately classified as having pornographic images. A database of known pornographic images is used as a starting point. A web spider inspecting each new web site examines each image on the site. When it finds an image that is present in the known pornographic image database, or is a close enough match to be associated with a known porn image, the entire site, or a subset thereof, is classified as being pornographic.

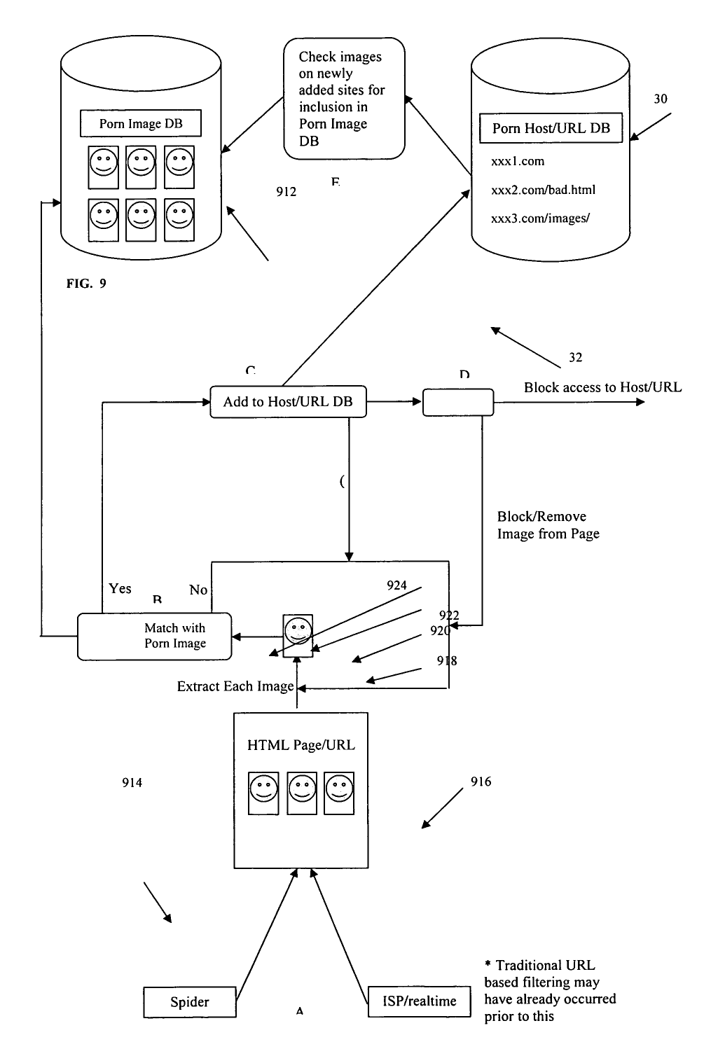

Referring to FIG. 9, the system contains a database of known pornographic images, 912. Web spider 914 explores the Internet looking for images. Images can also come from an Internet Service Provider (ISP) 916 or some other service that blocks pornography or monitors web page requests in real-time.

As a new web page 918 is obtained, each image 920, 922, 924 on the web page 918 is matched against images in the known pornography database 912 using a similar image search. If no match is found, the next image/page is examined. If a pornographic image is found, the host and/or the URL of the image are added to the known pornographic hosts/URL database 930 if it does not already exist in the database. The known pornographic hosts/URL database 930 can be used for more traditional hosts/URL type filtering and is a valuable resource.

When an image is found that is determined to be pornographic, an Internet Service Provider 932 or filter may choose to or be configured to block or restrict access to the image, web page, or the entire site.

In one embodiment of the invention, as new hosts and new URLs are added to the list of known pornographic websites, the system generates a list of those images that originated from pornographic hosts or URLs. The potentially pornographic images are marked as unclassified in the database until they can be classified by either an automated or human-assisted fashion for pornographic content. Those pornographic images can then be added to the known pornographic image database to further enhance matching. This system reduces the possibility of false positives.

Copyright/Trademark Infringement

In one embodiment, the technology described is used in an automated method to detect trademark and copyright infringement of a digital image. The invention is used in a general-purpose digital image search engine, or in an alternate embodiment, in a digital image search engine that is specifically implemented for trademark or copyright infringement searches.

A content-based matching algorithm is used to compare digital images. The algorithm, while capable of finding exact matches, is also tolerant of significant alterations to the original images. If a photograph or logo is re-sized, converted to another format, or otherwise doctored, the search engine will still find the offending image, along with the contact information for the web site hosting the image.

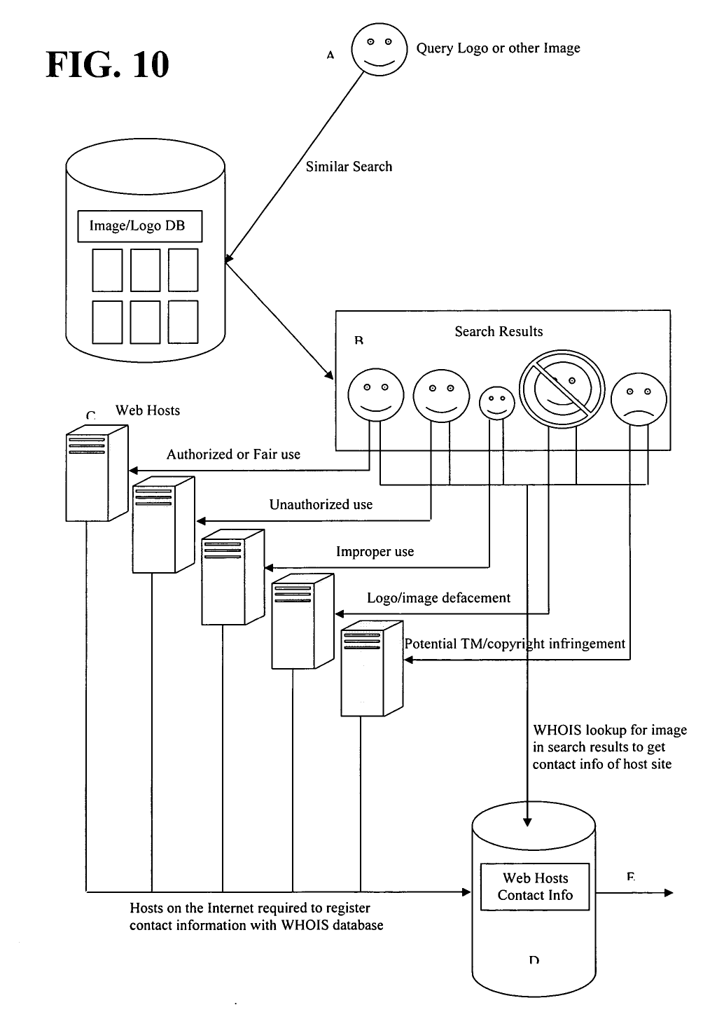

FIG. 10 depicts a method and system of detecting copyright or trademark infringement, in accordance with one practice of the present invention. A source image A is the copyrighted image and/or trademarked logo. Source image A is used as the basis for a search to determine whether unauthorized copies of image A, or derivative images based thereon, are being disseminated.

The source image A may come from a file on a disk, a URL, an image database index number, or may be captured directly from a computer screen display in accordance with conventional data retrieval and storage techniques. The search method described herein is substantially quality- and resolution-independent, so it is not crucial for the search image A to have high quality and resolution for a successful search. However, the best results are achieved when the source image is of reasonable quality and resolution.

The source image is then compared to a database of images and logos using a content-based matching method.

In one practice, the invention can utilize a search method similar to that disclosed above, or in the appendices. The described method permits both exact matches and matches having significant alterations to the original images to be returned for viewing. If the source image is similar or identical to the image on the database, the system records the image links to the owner of the similar image. Among other information, the search results for each image contain a link to the image on the host computer, a link to the page that the image came from, and a link that will search a registry of hosts for contact information for the owner of that host.

As shown in FIG. 10 at B, search results B show all of the sources on which an image similar or identical to source image A appear.

As shown in FIG. 10 at C, the Internet hosts that contain an image identical or similar to image A are displayed. As shown in FIG. 10 at D, a WHOIS database stores the contact information for the owners of each host in which a copy of the image A was found. All owners of hosts on the Internet are required to provide this information when registering their host. This contact information can be used to contact owners of hosts about trademark and copyright infringement issues.

Thus, the present invention thus enables automated search for all uses of a particular image, including licensed or permitted usages, fair use, unauthorized or improper use, and potential instances of copyright or trademark infringement.

Search for Items for Purchase (e.g. Shopping and Auction)

As ever-greater numbers of items and catalogs of items are available from network accessible resources, it has become increasingly difficult to use text to identify and locate items. Text-based search engines often are not successful and quickly locating items. In addition, items may not lend themselves to a thorough description due to a particular aesthetic or structural form.

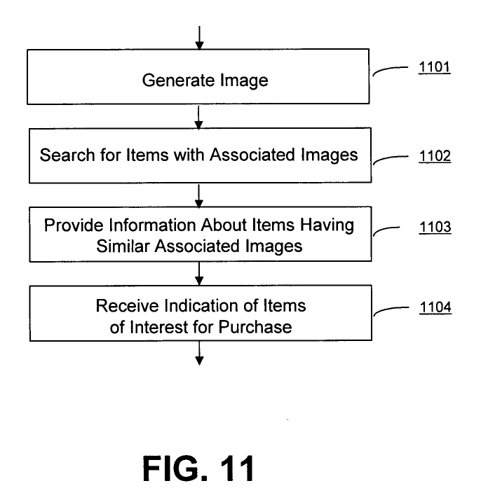

Referring to FIG. 11, in one embodiment, an image is generated (STEP 1101). In one embodiment, an image search capability, such as that described above, is used to identify items for purchase. The items can be any sort of tangible (e.g., goods, objects, etc.) or intangible (digital video, audio, software, images, etc.) items that have an associated image. An image to be used for search for a desired item is generated. The image can be any sort of image that can be used for comparison, such as a digital photograph, an enhanced digitized image, and/or a drawing, for example. The image can be generated in any suitable manner, including without limitation from a digital camera (e.g., stand-alone camera, mobile phone camera, web cam, and so on), document scanner, fax machine, and/or drawing tool. In one embodiment, a user identifies an image in a magazine, and converts it to a digital image using a document scanner or digital camera. In another embodiment, a user draws an image using a software drawing tool.

The image may be submitted to a search tool. A search is conducted (STEP 1102) for items having images associated which match the submitted image. The submitted image thus is used to locate potential items for purchase. The search tool may be associated with one or a group of sites, and/or the search tool may search a large number of sites. The image may be submitted by any suitable means, including as an email or other electronic message attachment, as a download or upload from an application, using a specialized application program, or a general-purpose program such as a web browser or file transfer software program. The image may be submitted with other information.

The user is presented with information about items that have an associated image that is similar to the submitted image (STEP 1103). In one embodiment, items currently available are presented in a display or a message such that they are ranked by the associated images' similarity with the submitted image. In one embodiment, items that were previously available or are now available are presented. In one embodiment, the search is conducted in an ongoing manner (i.e., is conducted periodically or as new items are made available for purchase) such that as new items are made available that match the search request, information is provided. The user can then select items of interest for further investigation and/or purchase (STEP 1104). The information may be presented in real-time, or may be presented in a periodic report about items that are available that match the description.

In some embodiments, additional information is used to perform the search. This can include text description of the item, text description of the image, price information, seller suggestions, SKU number, and/or any other useful information. The additional information may be used in combination with the image similarity to identify items. The items may be presented as ranked by these additional considerations as well as the associated images' similarity with the submitted image. In one embodiment, the combination of image search with other types of search provides a very powerful shopping system.

In one embodiment, such a tool is used for comparison shopping. A user identifies a desired item on one web site, and downloads the image from the web site. The user then provides the image to a search tool, which identifies other items that are available for purchase that have a similar appearance. The items may be those available on a single site (e.g., an auction site, a retail site, and so on) or may be those available on multiple sites. Again, additional information can be used to help narrow the search.

In one embodiment, the search tool is associated with one or a group of auction sites. A user submits an image (e.g., in picture form, sketch, etc.) that is established as a query object. The query object is submitted to a service, for example by a program or by a web-based service. Using the image as input, the service generates a list of auctions that have similar images associated with them. For example, all images having a similarity above a predetermined match level may be displayed. The user would then be able to select from the images presented to look at items of interest and pass or bid (or otherwise purchase) according to the rules of the auction. The user may be able to provide additional key words or information about the desired item to further narrow the search.

In another embodiment, a user provides the image as a search query, and using the image as (or as a part of the search query) the auction service notifies the user when new auctions have been created that having items with similar images. Thus, STEP 1102 and STEP 1103 are repeated automatically. The search can be run, and results communicated, periodically by the search service against its newly submitted auctions. The search also may be run as new auctions are submitted, against a stored list (e.g., a database) of users' image queries.

In one embodiment, the user is periodically notified when the user's searches have identified new items have sufficiently similar associated images. The user can then review the results for items of interest. In another embodiment, the user is notified as new items having a sufficiently similar associated image are submitted for sale.

A system for implementing the method may include a computer server for receiving search requests and providing the information described. The method may be implemented with software modules running on such a computer. The system may be integrated with, or used in combination with (e.g., as a service) to one or more existing search or ecommerce systems

Mobile Search

In one embodiment, the technology described above is used to enhance or enable a search from a mobile device. Here, mobile device is used to refer to any suitable device now available or later developed, that is portable and has capability for communicating with another device or network. This includes, but is not limited to a cellular or other mobile or portable telephone, personal digital assistant (e.g., Blackberry, Treo and the like), digital calculator, laptop or smaller computer, portable audio/video player, portable game console, and so on.

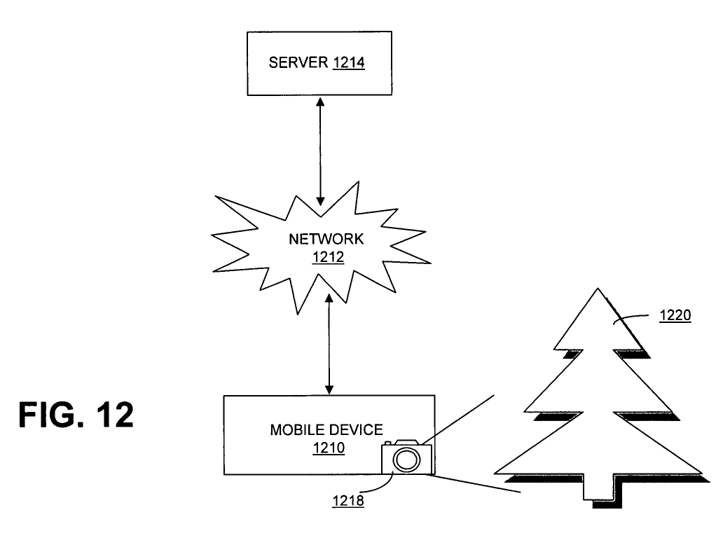

Referring to FIG. 12, the mobile device 1210 includes a camera 1212. The camera is depicted in the figure as a traditional camera, but it should be understood that a camera may be any sort of camera that may be used or included with a mobile device 1210, and may be integrated into the mobile device, attached via a cable and or wireless link, and/or in communication with the mobile device in any suitable manner.

The mobile device is in communication with a server 1212 via a network 1214. The server 1212 may be any sort of device capable of providing the features describe here, including without limitation another mobile device, a computer, a networked server, a special purpose device, a networked collection of computers, and so on. The network 1214 can be any suitable network or collection of networks, and may include zero, one or more servers, routers, cables, radio links, access points, and so on. The network 1214 may be any number of networks, and may be a network such as the Internet and/or a GSM telephone network.

The camera 1218 is used to take a picture of an object 1220. The object 1220, depicted here as a tree, may be anything, including an actual object, a picture or image of an object, and may include images, text, colors, and/or anything else capable of being photographed with the camera 1218. The mobile device 1210 communicates the image to the server 1212. The server 1212 uses the technology described above to identify images that are similar to the image transmitted by the mobile device 1210. The server 1212 then communicates the results to the mobile device 1210.

In one embodiment, the server 1212 communicates a list of images to the mobile device 1210, so that the user can select images that are the most similar. In another embodiment, the server 1212 first sends only a text description of the results, for further review by the user. This can save bandwidth, and be effective for devices with limited processing power and communication bandwidth.

In one embodiment, the mobile device has a tool or application program that facilitates the search service. The user takes a picture with the camera, using the normal procedure for that mobile device. The user then uses the tool to communicate the image to the server, and to receive back images and/or text that are the result of searching on that image. The tool facilitates display of the images one or two at a time, and selection by the user of images that are most similar to the desired image. The tool then runs the search iteratively, as described above using the images that were selected. The tool facilitates selection of the images with minimal communication back-and-forth between the mobile device and the network, in order to conserve processing power and communication bandwidth.

In another embodiment, the user sends the image as an attachment to a message, such as an SMS message. The search service then identifies and sends the results as a reply. In another embodiment, the search service sends a link to the results, that can be accessed with a web browser on the mobile device.

The technology described may be used with the shopping technology described above, for example, to check prices of items on-line, even from within a retail store. The technology may be used to locate restaurants, stores, or items for sale, by providing a picture of what is desired. The application running on the mobile device may facilitate the search by collecting additional information about the search, for example, what type of results are desired (e.g., store locations, brick-and-mortar stores that have this item, on-line stores that have the item, information or reviews about the item, price quotes), and/or additional text to be used in the search.

Video Search

TV quality video runs at 30 frames/second, with each frame a distinct image. In most cases, a minor change occurs from frame to frame, the presenting the perception of smooth movement of subjects visually. As such, a one-hour digitized video is comprised of approximately 108,000 sequential images. The MPEG standards (e.g., MPEG-4 standard) compress video in a variety of ways, with the result that it may be difficult to search through the video. In addition, due to the nature of video, typically, none of the frame images are described with text, such as tagged key words. Therefore, traditional search techniques for images labeled with key words is not possible. Manually scanning the video may be extremely labor intensive and subject to human error, especially when fatigue is a factor.

In one embodiment, images are extracted from digitized video into a data store of sequential images. The images then may be searched as described here to search within the video. An image from the video itself may be used to search, for example, to locate all scenes in a video that have a particular person or object. Likewise, a photograph of a person in the video, or an object in the video may be used.

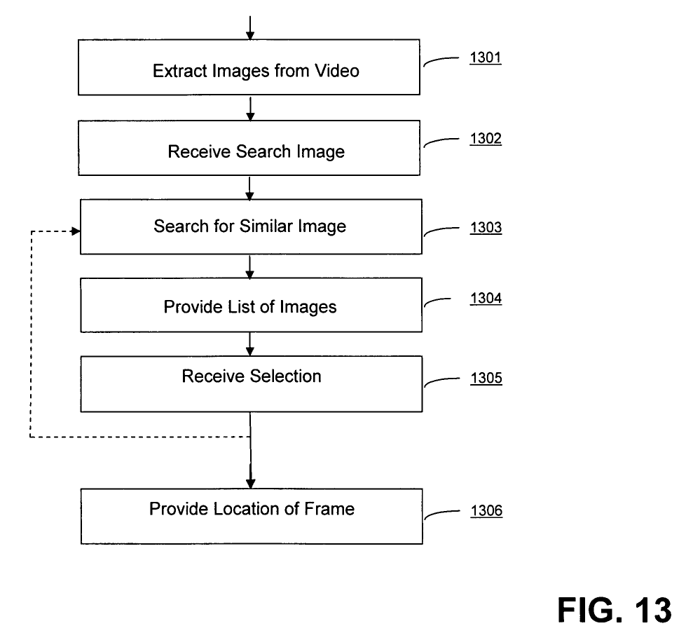

Referring to FIG. 13, in one embodiment, a search within one or more videos is performed by extracting images from video 1301. This may be accomplished by converting the video frame into digitized image data, which may be accomplished in a variety of ways. For example, software is commercially available that can extract image data from video data. The images may be stored in a database or other data store. All of the images may be extracted, or in some embodiments image data from a subset of the video frames may be extracted, for example, a periodic sample, such as one image each five seconds, two seconds, one second, half second, or other suitable period. It should be understood that the longer the period, the greater the fewer images that will need to be searched, but the greater the likelihood that some video data will be missed. In part, the period may need to be set based on the characteristics of the video content and the desired search granularity.

An image is received to be used for the search 1302. The image may be copied from another image, may be a photograph, or may be a drawing or a sketch, for example, that is received via a web cam, mobile telephone camera, image scanner, and the like. The image may be submitted to a search tool. The image may be received in an electronic message, for example, email or mobile messaging service. The image may be generated in any suitable manner, for example, using a pen, a camera, a scanner, a fax machine, an electronic drawing tool, and so forth.

A search is conducted 1303 for images in the data store that are similar to the search image. In this way, images that have similar characteristics or objects to the search image are identified. The user is provided with a list of images 1304 (and in some embodiments the associated frames, information about the frames, and so on).

The use may select an image that was extracted from a video frame 1305. This selection may be provided in any suitable manner, for example via an interface, message communication and so forth. The location of the frame associated with the image may be provided 1306. While, the numerical indication of the frame location may already have been provided with the image, it may be displayed again. In addition or instead, the use may view in the context of a video editor display or video player the approximate location of the identified frame. The user may also iteratively repeat the search within a specified time block, for example, a time block proximate to the frame from which the identified image was extracted. In one embodiment, iterative techniques may be used to manually refine results within a particular time block, or to focus on a segment of interest within a video.

In one embodiment, an iterative search may require that further images be extracted from the video. For example, in a demonstrative example, a user may search each of 5 second samples from a video. When the first set of frames are provided, the user may be able to identify that the time block between 2′20″ and 5′50″ are the most relevant. The user then could request that the same search be performed within that time range, at a smaller interval. If the decomposed images are already in the data store, then the system could immediately conduct the search. If the images are not available, the system could then decompose images during the time interval 2′20″ and 5′50″ of the video, at a greater sample rate, for example, on image every 10^{th} of a second.

In one embodiment, an image is provided as a query object. Using that image as search input, the user initiates a request for similar images in a database of images that have been extracted from a video. Results showing similar images, ranked by similarity scores, would be displayed as small thumbnail images on the output display. The user would be able to scroll through the similar images presented and select one most consistent with the search objective, combining nearly identical images to focus on a particular video segment.

A system for implementing such a method may include a computer having sufficient capability to process the data as described here. It may use one or a combination of computers, and various types of data store as are commercially available. The method steps may be implemented by software modules running on the computer. For example, such a system may include an extraction subsystem for extracting images from video. The system may include a receiving subsystem for receiving a search image, a search subsystem for searching for a similar image. A reporting subsystem may provide the list of images, and a selection subsystem may receive the user's selection. The reporting subsystem, or an indication subsystem may provide the location of the frame. The reporting subsystem may interface with another subsystem such as a video player (which may be software or a hardware player) or editing system. Some or all of the subsystems may be implemented on a computer, integrated in a telephone, and/or included in a video, DVD or other special-purpose playing device.

Multiple Images

In one embodiment, multiple images may be used to conduct a search, such that the results that are most similar to each of the images are shown to have the highest similarity. This is particularly useful in the iterative process, but may also be used by taking multiple pictures of the desired object, to eliminate artifacts. This may be performed by identifying similarity between the images, and using that similarity, or by running separate searches for each of the images, and using the results that are highest for each of the images.

The attached Appendix includes additional disclosure, incorporated hereto: W. Miblack, R. Barber, W. Equitz, M. Flicker, E. Glasman, D. Petkovic, R. Yanker, C. Faloutsos, and G. Taubin, The QBIC project: Querying images by content using color, texture, and shape, in Storage and Retrieval for Image and Video Databases, SPIE, 1993; J. Smith, S. F. Chang, Integrated Spatial and Feature Image Query, ACM Multimedia 1996; and C. Jacobs, A. Finkelstein, D. Salesin, Fast Multiresolution Image Querying in Computer Graphics, 1995.

What is claimed is:

1-14. (canceled)

15. A method for identifying items for purchase, comprising:
receiving a search image for use in search for a desired item;
searching for stored images in the data store for items that have associated images that are similar to the search image; and
providing information about items that have associated images that are similar to the search image in response to the search.

16. The method of claim 15, wherein the search image is a drawing.

17. The method of claim 15, wherein the search image is a photograph.

18. The method of claim 15 wherein the search image is received in an electronic message.

19. The method of claim 15 wherein the search image is received as an upload.

20. The method of claim 15 wherein the search image is received as a pointer to a location from which the search image may be downloaded.

21. The method of claim 20 wherein the pointer is a URL.

22. The method of claim 15 wherein the search image is received from a camera in a mobile telephone.

23. The method of claim 15 wherein the search image is a photograph from a magazine that has been scanned by a user.

24. The method of claim 15 wherein the search image is received by fax.

25. The method of claim 15 wherein the item is a tangible item that has an associated image.

26. The method of claim 15 wherein the item is an intangible item that has an associated image.

27. The method of claim 15 wherein the images are presented such that they are ranked by the associated image similarity with the submitted image.

28. The method of claim 15 wherein additional information is used to perform the search.

29. The method of claim 28 wherein the additional information comprises a text description of the item, text description of the image, price information, seller suggestions, SKU number, any other useful information, and/or some combination.

30. The method of claim 15 wherein the search image is received from a user who has identified an item and has provided an image of the item for purposes of comparison shopping.

31. The method of claim 15, wherein items are provided from time to time as they are made available for sale.

32. The method of claim 15, wherein items are provided via an electronic message notification.

33. The method of claim 15, wherein items currently available are provided in a list.

34. The method of claim 15, wherein the items are provided via a display on a web site.

35. The method of claim 15, wherein the search comprises:
decomposing the search image into at least one mathematical representation representative of at least one parameter of the digital image;
using the mathematical representation to test each of a plurality of mathematical representations of database images stored in a database; and
designating as matching images any database images with mathematical representations having a selected goodness-of-fit with the mathematical representation of the input image.

36. The method of claim 15, further comprising:
organizing the image data store into clusters, each cluster containing images within a selected threshold of visual similarity,
examining, in response to the search image, a representative node from each cluster, and
displaying the search results by displaying the representative node, while enabling a user to browse through the cluster to view other nodes of the cluster.
